(19) United States
(12) Patent Application Publication
(10) Pub. No.: US 2023/0403998 A1
(43) Pub. Date: Dec. 21, 2023

(54) Portable Watering Apparatus With Indicia For Determining Remaining Volume of Liquid During Watering

(71) Applicants: Mary Naber, Del Mar, CA (US); Angela King, Del Mar, CA (US); Katarina King, Del Mar, CA (US); Caleb King, Del Mar, CA (US)

(72) Inventors: Mary Naber, Del Mar, CA (US); Angela King, Del Mar, CA (US); Katarina King, Del Mar, CA (US); Caleb King, Del Mar, CA (US)

(21) Appl. No.: 18/206,287

(22) Filed: Jun. 6, 2023

Related U.S. Application Data
(60) Provisional application No. 63/352,378, filed on Jun. 15, 2022.

(51) Int. Cl. A01G 25/14

(52) U.S. Cl. CPC A01G 25/14

(57) ABSTRACT

In the examples described herein, a portable watering apparatus includes a reservoir with at least one transparent sidewall having volume dispensing measuring indicia. A spout is connected at or near the bottom of reservoir. When the apparatus is tilted to a watering angle, liquid flows from the reservoir through the spout to exit the apparatus. The indica allows the user to determine the remaining volume of liquid in the reservoir while the apparatus is positioned at the watering angle. As the liquid flows, the volume of liquid dispensed can be determined by observing the change in liquid level relative to the indicia.

### CLAIM OF PRIORITY

The present application claims priority to U.S. Provisional Application No. 63/352,378, entitled “PORTABLE WATERING APPARATUS WITH INDICIA FOR DETERMINING REMAINING VOLUME OF LIQUID DURING WATERING”, filed June 2022, which is assigned to the assignee hereof and hereby expressly incorporated by reference in its entirety.

### FIELD

This invention generally relates to liquid containers and more particularly to portable watering containers with indicia for determining remaining volume liquid during watering.

### BACKGROUND

Portable watering containers are used to water plants by tipping the container at an angle relative to Earth such that water or other liquid is poured from the container to the desired location. Portable watering containers are sometimes referred to as watering cans, watering pots, and sprinkling cans. A watering container is typically made from plastic or metal and includes a spout connected to storage area. The user grips a handle and tips the can such that the liquid moves from the storage area and through the spout. Conventional watering containers are opaque which does not allow the user to determine the volume of liquid in the storage area.

### BRIEF DESCRIPTION OF THE DRAWINGS

It is to be understood that the drawings are solely for purpose of illustration and do not define the limits of the appended claims. Furthermore, the components in the figures are not necessarily to scale. The figures are general visual representations of the feature and components and are not necessarily intended to represent distances or sizes to scale or accurately depict the shapes of the components that are discussed. In the figures, like reference numerals designate corresponding parts throughout the different views.

FIG. 1A is an illustration of a perspective view of a portable watering apparatus having volume dispensing measuring indicia when the portable watering apparatus is in a non-watering orientation.

FIG. 1B is an illustration of a perspective view of the portable watering apparatus in a watering orientation.

FIG. 2A is an illustration of a side view of the portable watering apparatus in a watering orientation where the reservoir is a hollow rectangular prism with rounded corners having a length greater than the width.

FIG. 2B is an illustration of a side view of the portable watering apparatus in a watering orientation for an example where only a portion of the reservoir wall is translucent.

FIG. 3 is an illustration of an example of volume dispensing measuring indicia 300 comprising a plurality of lines.

FIG. 4A is an illustration of a perspective view of an example of a system including a watering basin and a portable watering apparatus.

FIG. 4B is an illustration of a perspective view of the water apparatus and basin system while being used for watering a plant container.

FIG. 4C is an illustration of a perspective view of the system while the apparatus is refilled by the watering basin with the drained liquid.

FIG. 5A is an illustration of a perspective view of one example of a watering basin.

FIG. 5B is an illustration of a perspective view of second example of a watering basin.

FIG. 5C is an illustration of a perspective view of a third example of a watering basin.

FIG. 5D is an illustration of a perspective view with an expanded cross-sectional sideview portion of a watering apparatus-basin system including a fourth example of a watering basin that includes elevation features.

### DETAILED DESCRIPTION

In the examples described herein, a portable watering apparatus includes a reservoir with at least one transparent sidewall having volume dispensing measuring indicia. A spout is connected at or near the bottom of reservoir. When the apparatus is tilted to a watering angle, liquid flows from the reservoir through the spout to exit the apparatus. The indica allows the user to determine the remaining volume of liquid in the reservoir while the apparatus is positioned at the watering angle. As the liquid flows, the volume of liquid dispensed can be determined by observing the change in liquid level relative to the indicia.

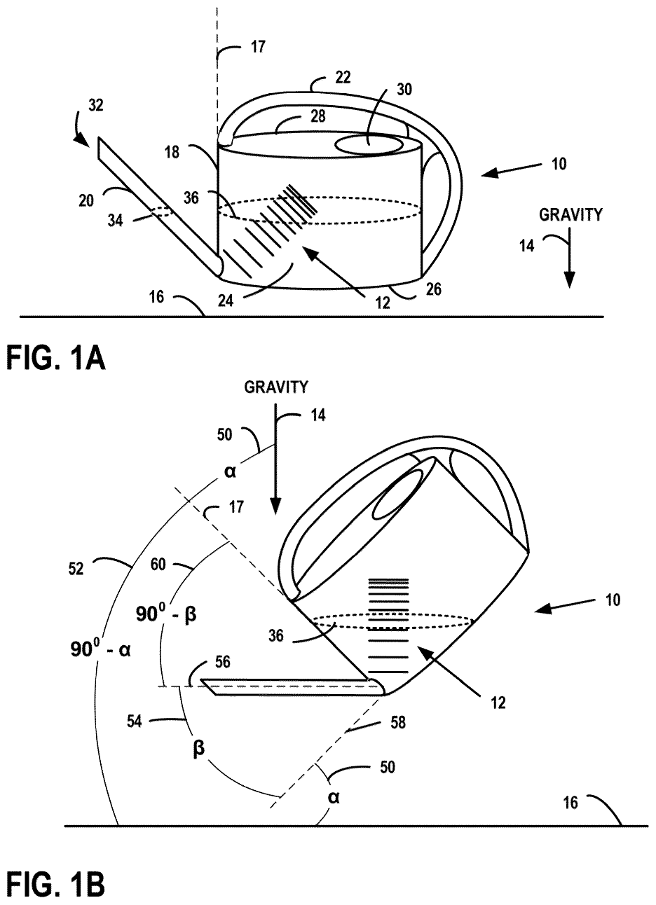

FIG. 1A is an illustration of a perspective view of a portable watering apparatus 10 having volume dispensing measuring indicia 12 when the portable watering apparatus 10 is in a non-watering orientation. For the example of FIG. 1A, the non-watering orientation is an orientation when the portable watering apparatus 10 is resting on a flat surface that is perpendicular to the direction of gravity 14. The line 16 in FIG. 1A represents the angle of the plane that is perpendicular to the direction of gravity 14. The vertical axis 17 of the portable watering apparatus 10 is parallel to gravity 14.

For the examples herein, the portable watering apparatus 10 includes a reservoir 18, a spout 20 and a handle 22. The reservoir 18 is configured to contain a liquid such as water or a water mixture that is to be used for watering plants. The reservoir is formed by one or more vertical sides 24, and a bottom 26. For the example, the reservoir 18 also includes a top 28 having a fill opening 30 for accepting the liquid for watering. In some situations, the top 28 may be omitted. The bottom 26 is configured to rest on a flat surface in the non-watering orientation. The reservoir 18 may have any of numerous shapes. In one example, the reservoir 18 is a hollow rectangular prism with rounded corners having a length greater than its width where the length is from the front of the reservoir where the spout 20 is attached to the back. For such an example, therefore, the reservoir 18 includes four sides. In another example, a single side forms a cylindrical wall which may be circular or oval shaped as viewed from the top or bottom. In another example, the reservoir is a cube. The side or sides may be parallel to gravity and, therefore, perpendicular to the bottom 26 in some implementations. In other situations, the sides may be angled such that the top 28 is smaller than the bottom 26. In still other situations, the sides may be angled such that the top 28 is larger than the bottom 26.

At least a portion of the reservoir 18 is sufficiently transparent to allow the user to determine where the liquid is present in the reservoir. The volume dispensing measuring indicia 12 is positioned on the reservoir 18 to allow the user to determine a change in the level of the liquid relative to the indicia 12 while the apparatus is used for watering. For example, the indicia 12 may include several lines where a change in liquid level from one line to another line corresponds to a set volume of liquid being dispensed from the spout 20. Since the indicia 12 has a portion and orientation to be used when the apparatus 10 is in a predetermined watering orientation, the indica may appear as angled relative to the water level when the apparatus 10 is in the non-watering orientation.

The spout 20 is a hollow tubular member connected at, or near, the bottom 26 and extends away from the reservoir 18. The spout 20 has a configuration such that liquid flows from the reservoir, through the spout 18, and out a spout opening 32 when the portable watering apparatus 10 is tilted at a sufficient angle relative to the direction of gravity 14. The level 34 of liquid in the spout 18 matches the level 36 of liquid in the reservoir when the watering apparatus 10 is in the non-watering orientation. The spout opening 32, therefore, is positioned above the highest level of the liquid when the reservoir is full in order that the liquid does leak out of the spout 18 until the portable watering apparatus 10 is used for watering. For the example, the spout is straight. In other examples, the spout may be curved with one or more curves. The spout opening 32 may be a single opening in some examples. In other examples, the spout opening may include multiple smaller openings such a sprinkler head spray spout. In some situations, the spout may include a detachable sprinkler head such that a single opening may be used without the sprinkler head and multiple smaller openings can be used with the sprinkler head. In one example, multiple sprinkler heads with different watering patterns may be attached such that the user may select the desired watering configuration by either omitting the sprinkler head to use the single opening spout or selecting a preferred sprinkler head from the set of multiple sprinkler heads.

The handle 22 in the example is configured such that the portable watering apparatus 10 can be carried when not being used for watering and can be manipulated during watering. The handle 22 is attached to the reservoir 18 at both ends of the handle 22. For the example, the handle is also attached at third location on the reservoir 18. Other attachment configurations can be used in other examples.

FIG. 16 is an illustration of a perspective view of the portable watering apparatus 10 in a watering orientation. In the watering orientation, the apparatus is tilted at a watering angle (0) 50 relative to gravity 14. The vertical axis 17 of the apparatus 10, therefore, is at the watering angle (a) 50 relative to the direction of gravity 14 when the apparatus 10 is in the watering orientation. The complementary angle 52 is the angle to the plane 16 that is perpendicular to gravity 14. The spout angle (3) 54 is the angle between the spout axis 56 of the spout 20 and the plane 58 of the bottom 26 of the reservoir 18. For the examples, the apparatus 10 has a configuration such that the spout axis 56 is perpendicular, or nearly perpendicular, to gravity 14 when the apparatus 10 is in the watering position. The spout angle (0) 54 is determined based on the desired watering angle 50 and shape of the reservoir 18. For the examples herein, the spout angle is at or near 45 degrees. Such a configuration is advantageous where the watering angle is 45 degrees and the shape of the reservoir 18 can be emptied in the watering orientation. Although the apparatus 10 may be used in an orientation other than the watering orientation to perform watering, the indica 12 will appear at an angle to the water line 36 in such situations since the orientation of the indica 12 is selected based on the desired watering angle. For the examples herein, therefore, the apparatus has a configuration intended to be used at, or near, a single watering angle. Examples of a single intended watering angle include an angle selected between 35 and 55 degrees. A single intended watering angle may also be selected between 40 and 50 degrees where the reservoir can be emptied at the selected angle. The single intended watering angle may also be selected from a narrower range around 45 degrees where such examples of these ranges include ranges of 41 to 49 degrees, 42 to 48 degrees, 43 to 47 degrees, 44 to 46 degrees, and 44.5 to 45.5 degrees.

The apparatus has a spout angle 58 selected in accordance with the complement angle 52 to the watering angle 50. Stated differently, the apparatus has a spout angle 58 selected such that the compliment angle 60 to the spout angle 58 is the same or near the watering angle 50. For the examples, the spout angle 58 is the same as the compliment angle 52. The spout angle 54, however, may be slightly different than the compliment angle 52 in some situations.

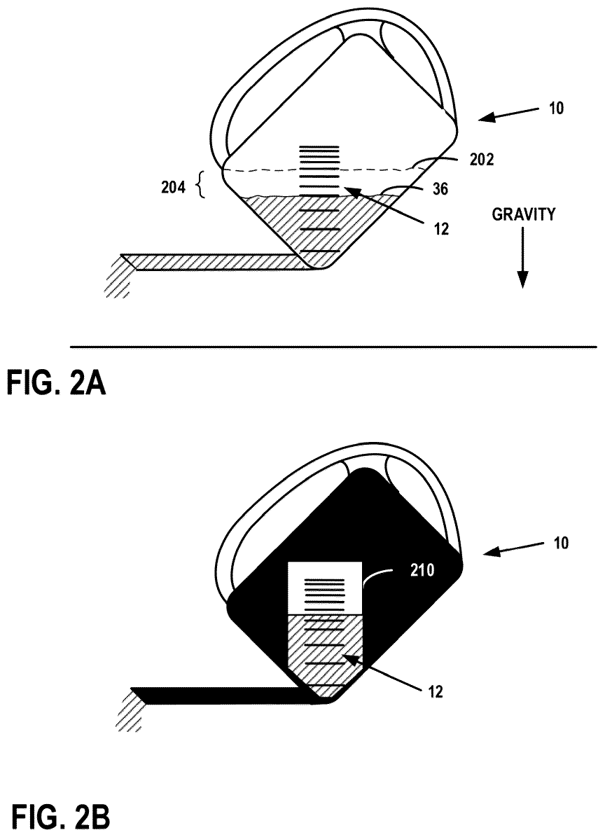

FIG. 2A is an illustration of a side view of the portable watering apparatus 10 in a watering orientation where the reservoir is a hollow rectangular prism with rounded corners having a length greater than the width. For the example, the reservoir 18 and the spout 20 are at least translucent and may be transparent. The material forming the reservoir 18 and spout 20, therefore, allows enough light to pass through the walls of the components to allow the user to determine the presence of the liquid and the absence of the liquid. The liquid level 36 can be seen from the exterior of the apparatus 10. In addition, the liquid level 36 can be viewed relative to the indicia 12 on the wall of the reservoir 10. During the watering process, the user tips the apparatus 10 to the watering angle to place the apparatus in the watering orientation and takes note of the initial level 202 of the liquid in the reservoir 18. As the liquid pours from the spout 20, the liquid level drops from the initial liquid level 202 to a current liquid level where the difference 204 between levels corresponds to the volume of liquid dispensed. The indicia 12 includes distributed demarcations where each spacing between adjacent demarcations corresponds to a volume of liquid. For the example, the space between each set of adjacent demarcations corresponds to the same volume of liquid. In some circumstances, the spacings may correspond to different volumes. Further the demarcations may include two or more demarcations having different characteristics where spaces between adjacent demarcations of the different types correspond to different liquid volumes. For example, the indicia 12 may include a plurality of lines where spaces spaces between lines of one length correspond to a 0.5 cups and spaces between longer lines correspond to 1.0 cups. As discussed below in further detail, the spacing between adjacent demarcations corresponding to a specific dispensed volume of liquid may differ in some situations.

FIG. 28 is an illustration of a side view of the portable watering apparatus 10 in a watering orientation for an example where only a portion 210 of the reservoir wall is translucent. Although in some examples the entire apparatus may be formed by a translucent material, only a portion 210 of the apparatus is translucent for the example of FIG. 2B. The indicia 12 is within the translucent portion 210 which forms a window allowing the user to determine the liquid level.

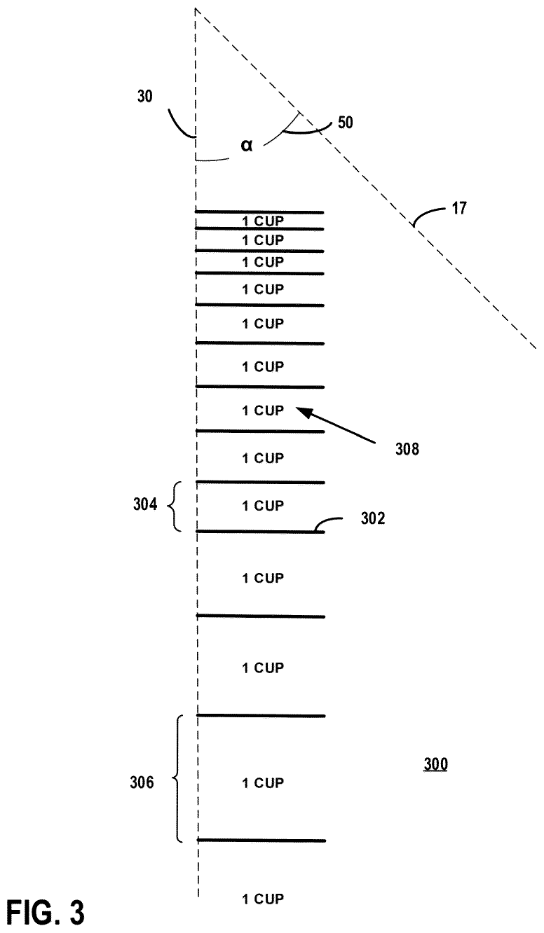

FIG. 3 is an illustration of an example of volume dispensing measuring indicia 300 comprising a plurality of lines 302. The volume dispensing measuring indicia 300 of FIG. 3 is, one, example of the volume dispensing measuring indicia 12. The plurality of lines 302 are horizontal and, therefore, parallel to the liquid level 36 when the apparatus is in the watering orientation. For the example, the spacings between adjacent lines correspond to a dispensed liquid volume of 1 cup. The volume dispensing measuring indicia 300 is implemented with a reservoir 18 having shape where the surface area of the remaining liquid decreases as the reservoir 18 is emptied while in the watering orientation. As a result, a dispensed volume of 1 cup corresponds to larger change in the height of the liquid level 36 as the total remaining volume of liquid decreases. A spacing 304 between adjacent lines closer to the top of the indica 300 is smaller than a spacing 306 between adjacent lines closer to the bottom of the indica 300. In other examples, the spacing between lines may be equal where each spacing corresponds to the same volume of liquid. Such configuration may be appropriate where the shape of the reservoir results in a linear relationship between the volume of dispensed liquid and the vertical distance change in liquid level. In still other examples, the spacing between in lines may be the same but may correspond to different volumes of dispensed liquid. Other combinations and relationships between the indicia and dispensed liquid are also possible.

The indicia 300 also includes text 308 that represents the dispensed volume of liquid between adjacent lines. Although the dispensed volume between each set of adjacent lines is the same for the example, the lines may be arranged to provide for different volumes between different sets of adjacent lines. In such a situation, the text 308 may reflect the different volumes. The selection of the dispensed represented by the spacing between adjacent lines may depend on the total volume of the reservoir 18, the desired level of precision for measuring the volume of dispensed liquid, the ease of viewing the components of the indicia 300, and other factors.

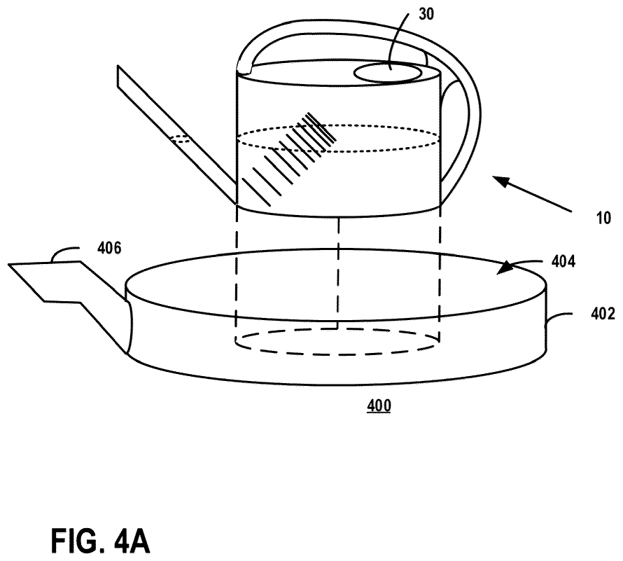

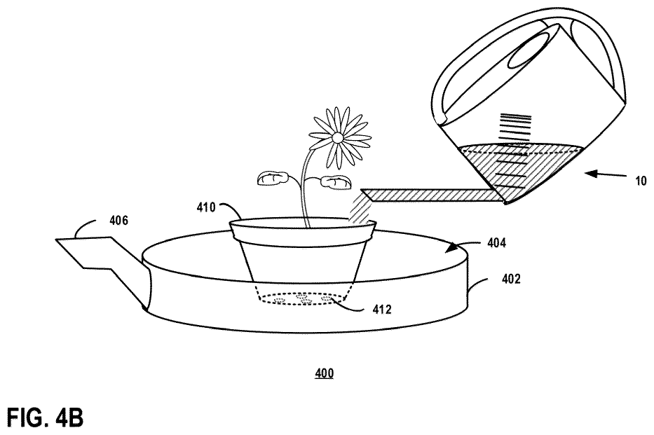

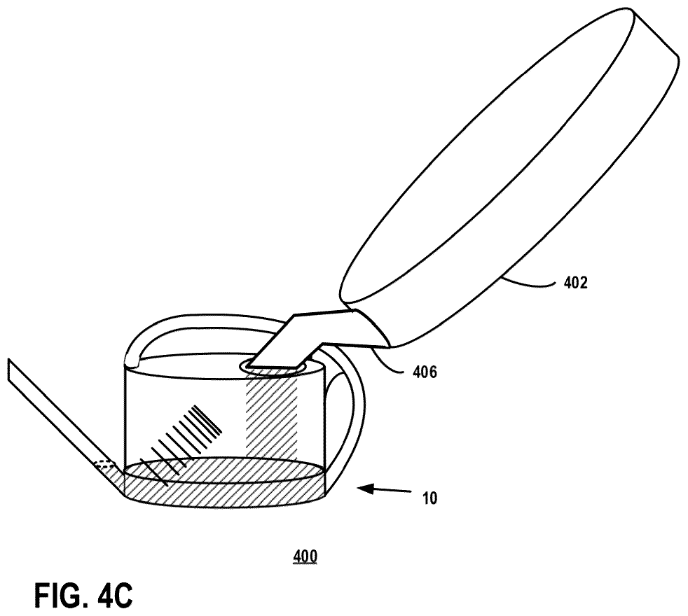

FIG. 4A is an illustration of a perspective view of an example of a system 400 including a watering basin 402 and a portable watering apparatus 10. The watering basin 402 is configured to accept and hold the portable watering apparatus 10 within a bowl portion 404 when the portable watering apparatus 10 is in the non-watering orientation and when the apparatus 10 is stored and not being used. When the system 400 is used for watering, a draining plant container or pot is placed in the bowl portion 404 such that liquid draining through the container is captured by the bowl portion 404 while the container is watered. The watering basin 402 includes a refilling spout 406 that has a configuration and size to snugly fit into the fill opening 30 of the apparatus 10.

FIG. 4B is an illustration of a perspective view the system 400 while being used for watering a plant container 410. The plant container 410 is any type of planter, pot, or other plant holding apparatus, that is configured to allow liquid to drain from the container. Accordingly, the bottom of the container 410 typically includes one or more drain openings 412. As the plant is watered, some of the liquid drains through the container 410 into the bowl portion 404. The drained liquid may include more than the liquid being poured from the apparatus 10. For example, if a mixture of water and liquid fertilizer is used for watering, the drained liquid may include some pieces of soil, nutrients, or other materials from the contents of the container 410 in addition to the water and liquid fertilizer. The system 400, therefore, provides a method for not only recapturing the original watering liquid but also for capturing other valuable materials draining for the container 410.

FIG. 4C is an illustration of a perspective view of the system 400 while the apparatus 10 is refilled by the watering basin 402 with the drained liquid. As mentioned above, the refilling spout 406 has a configuration and size to snugly fit into the fill opening 30 of the apparatus 10. The snug fit reduces spillage and allows the two components to be easily aligned during the refilling procedure. Although the example of FIG. 4A, FIG. 4B, and FIG. 4C includes a transparent portable watering apparatus 10 with volume dispensing measuring indicia 300, the system may be used with other types of watering cans.

The watering basin 402 may have any of several configurations, shapes ar d sizes. For the examples discussed herein, the configuration, shape and size of the watering basin is selected in accordance with the configuration, shape and size of the watering apparatus 10. An example of suitable size includes the watering basin 402 being large enough to hold the watering apparatus 10 when the system is stored or not in use but small enough to minimize the overall size of the system. In most situations, the configuration and shape of the watering basin 402 complements the shape and configuration of the watering apparatus 10. For example, a rectangular water basin may be used with a rectangular watering apparatus. The configuration of the watering basin 402 may be selected to form a reciprocal fit between the apparatus 10 and the basin 402. Features of the watering apparatus 10, therefore, may fit into features of the watering basin 402. For example, the spout 406 of the watering basin 402 may be configured to accept the spout 20 of the watering apparatus 10 when the system is stored.

For the examples herein, the watering basin 402 is at least translucent and may be transparent. The watering basin 402 may include other features or characteristics in some situations. For example, the watering basin 410 may include indicia that indicates the volume of liquid in the bowl portion 404. In other examples, as discussed below, the watering basin 402 may include a strengthened and/or widened rim at the top of the bowl portion 404 that allows for resting the flower pot on the edge of the watering basin to allow access liquid to drain from the flower pot into the bowl portion 404. Examples of other features that may be included in the watering basin 402 include bumps or spacers at the bottom of the bowl portion which allow the flower pot being watered to be lifted off of the bottom of the bowl portion. Such features may allow the water to drain more freely as compared to a flower pot that rests on the bottom of the bowl portion where the bottom of the flower pot is submerged in liquid.

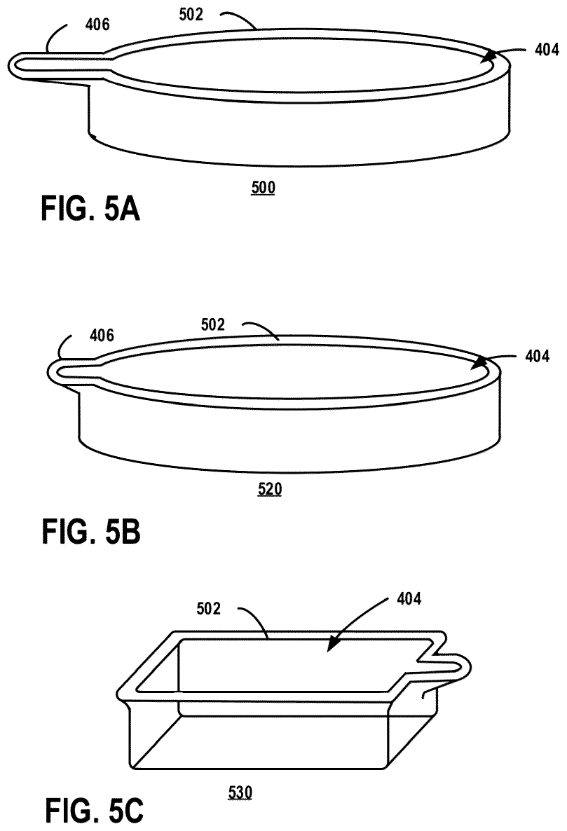

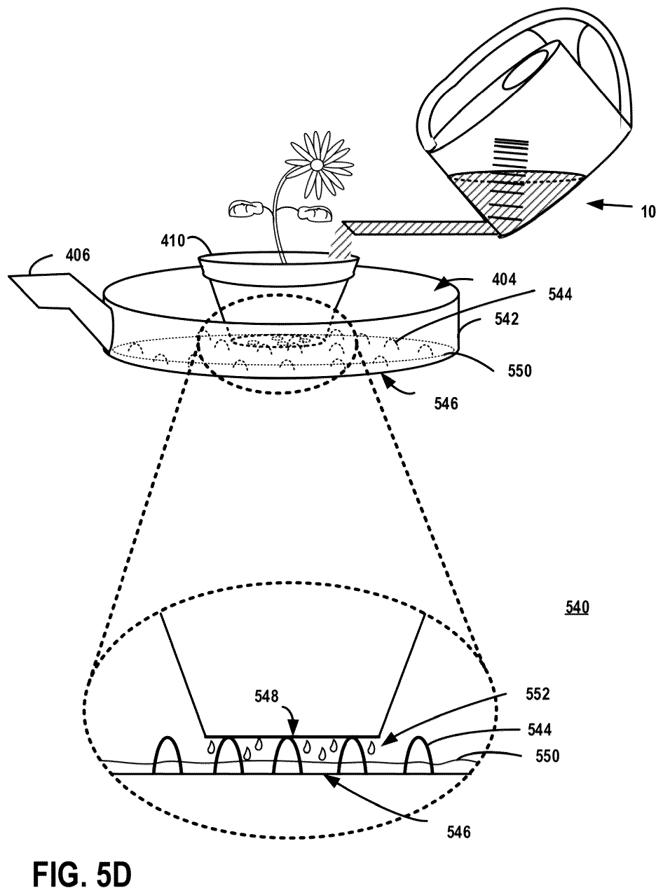

FIG. 5A is an illustration of a perspective view of one example of a watering basin 500. The watering basin 500, therefore, is one example of the watering basin 402 discussed herein. The bowl portion 404 of the watering basin 500 has an oval shape. The spout 406 is connected near the top of the bowl portion 404 such that the contents of the bowl portion 404 may be poured into the watering apparatus 10 without excessive tilting of the watering basin 500. For the example of FIG. 5A, the spout extends laterally from the bowl portion 404. In some situations, the spout may be angled upward. The bowl portion 404 includes a rim 502 that provides a resting surface for a flower pot being watered. The rim 502 has sufficient strength and width that allow the user to rest a bottom edge of the flower pot on the rim 502 while allowing water to drain into the bowl portion 404. The rim 502, therefore, may be wider and have a greater strength than the walls of the bowl portion 404 in some situations.

FIG. 5B is an illustration of a perspective view of second example of a watering basin 520. The watering basin 520, therefore, is one example of the watering basin 402 discussed herein. The bowl portion 404 of the watering basin 520 has an oval shape. The spout 406 is connected near the top of the bowl portion 404 such that the contents of the bowl portion 404 may be poured into the watering apparatus 10 without excessive tilting of the watering basin 520. For the example of FIG. 5B, the spout extends from the bowl portion 404 less than the spout 406 extends from the bowl portion 404 in the example of FIG. 5A.

FIG. 5C is an illustration of a perspective view of a third example of a watering basin 530. The watering basin 530, therefore, is one example of the watering basin 402 discussed herein. The bowl portion 404 of the watering basin 530 has a rectangular shape. The spout 406 is connected near the top of the bowl portion 404 such that the contents of the bowl portion 404 may be poured into the watering apparatus 10 without excessive tilting of the watering basin 530.

FIG. 5D is an illustration of a perspective view with an expanded cross-sectional sideview portion of a watering apparatus-basin system 540 including a fourth example of a watering basin 542 that includes elevation features 544. The elevation features 544 can be any bumps, pins, or posts that extend from the bottom 546 of the watering basin 542. The elevation features 544 may be part of the bottom 546 or may be attached to the bottom 546. The tops of the elevation features 544 provide a surface for supporting the bottom 548 of the plant container (e.g., flower pot) 410 being watered such that the bottom 548 of the plant container 410 is elevated above the liquid level 550 in the bowl portion 404. Excess water 552 easily drains from the plant container 410 when the container 410 is resting on the elevation portions 544. The number of elevation features 544 may depend on factors such as the size of the watering basin, the size of the elevation features 544, and the desired elevation level. In some situations, a single elevation feature may be used. Such an implementation may include a single pedestal with a flat top positioned near the center of the watering basin. The height of the elevation features may be selected to provide the desired maximum liquid level. In some situations, the height of the elevation feature(s) is limited to minimize the size of the system 540 where the watering apparatus rests on the elevations features during storage.

As discussed above the watering basin and the watering apparatus may have reciprocal features such that the two devices fit together. In some situations, therefore, the watering apparatus may include concave features on the bottom 26 such that the elevation features can fit within the concave features during storage. Such a configuration may result in a form factor of the system 540 that is not any taller than a system that does not include elevation features.

Other types of elevation mechanisms may be used in some situations. One example of such a mechanism includes a grill that extends across the bowl portion. The grill may be permanently attached or may be removable. In another example, a wire mesh may be hooked to features within the bowl portion during watering to elevate the plant container above the liquid level. Such a configuration provides the advantage of allowing the wire mesh to be unhooked and placed at the bottom of the bowl portion during storage to minimize the height of the watering apparatus-basin system.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A portable watering apparatus comprising:
a reservoir configured to hold a liquid, the reservoir comprising a reservoir sidewall having at least a portion that is translucent allowing a level of the liquid to be observed when the portable watering apparatus is in a watering orientation, the portable watering apparatus tilted at a watering angle relative to a direction of gravity when the portable watering apparatus is in the watering orientation, the reservoir having a configuration allowing the liquid to exit the reservoir at every level of liquid when the portable watering apparatus is in the watering orientation; and
volume dispensing measuring indicia disposed within the at least a portion, the volume dispensing measuring indicia indicating a dispensed volume of liquid when observed relative to a change in the level of liquid as the liquid is dispensed.

2. The portable watering apparatus of claim 1, wherein the volume dispensing measuring indicia comprises a plurality of lines parallel to a top surface of the level of liquid when the portable watering apparatus is in the watering orientation.

3. The portable watering apparatus of claim 2, wherein a spacing between adjacent lines of the plurality of lines parallel corresponds to volume of liquid dispensed.

4. The portable watering apparatus of claim 3, wherein each spacing between adjacent lines corresponds to a same volume of liquid dispensed.

5. The portable watering apparatus of claim 1, wherein the watering angle relative to the direction of gravity is an angle between 40 degrees and 50 degrees.

6. The portable watering apparatus of claim 5, wherein the watering angle relative to the direction of gravity is an angle between 43 degrees and 47 degrees.

7. The portable watering apparatus of claim 6, wherein the watering angle re ative to the direction of gravity is an angle between 44 degrees and 46 degrees.

8. The portable watering apparatus of claim 7, wherein the watering angle relative to the direction of gravity is an angle between 44.5 degrees and 45.5 degrees.

9. The portable watering apparatus of claim 8, wherein the watering angle relative to the direction of gravity is equal to 45 degrees.

10. A watering system comprising:
a watering basin; and
a portable watering apparatus configured to fit inside the watering basin when the portable watering apparatus is not in use, portable watering apparatus comprising:
a reservoir configured to hold a liquid, the reservoir comprising a reservoir sidewall having at least a portion that is translucent allowing a level of the liquid to be observed when the portable watering apparatus is in a watering orientation, the portable watering apparatus tilted at a watering angle relative to a direction of gravity when the portable watering apparatus is in the watering orientation, the reservoir having a configuration allowing the liquid to exit the reservoir at every level of liquid when the portable watering apparatus is in the watering orientation; and
volume dispensing measuring indicia disposed within the at least a portion, the volume dispensing measuring indicia indicating a dispensed volume of liquid when observed relative to a change in the level of liquid as the liquid is dispensed.

11. The watering system of claim 10, wherein the volume dispensing measuring indicia comprises a plurality of lines parallel to a top surface of the level of liquid when the portable watering apparatus is in the watering orientation.

12. The watering system of claim 11, wherein a spacing between adjacent lines of the plurality of lines, parallel corresponds to volume of liquid dispensed.

13. The watering system of claim 12, wherein each spacing between adjacent lines corresponds to a same volume of liquid dispensed.

14. The watering system of claim 10, wherein the watering angle relative to the direction of gravity is an angle between 40 degrees and 50 degrees.

15. The watering system of claim 14, wherein the watering angle relative to the direction of gravity is an angle between 43 degrees and 47 degrees.

16. The watering system of claim 15, wherein the watering angle relative to the direction of gravity is an angle between 44 degrees and 46 degrees.

17. The watering system of claim 16, wherein the watering angle relative to the direction of gravity is an angle between 44.5 degrees and 45.5 degrees.

18. The watering system of claim 17, wherein the watering angle relative to the direction of gravity is equal to 45 degrees.
